(19) United States
(12) Patent Application Publication
(10) Pub. No.: US 2006/0077266 A1
(43) Pub. Date: Apr. 13, 2006

(54) Image processing in a communication device having a camera

(75) Inventor: Mikko Nurmi, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/961,712

(22) Filed: Oct. 8, 2004

(51) Int. Cl. H04N 5/262; H04N 5/222; H04M 1/00

(52) U.S. Cl. 348/239; 348/333.01; 455/556.1

(57) ABSTRACT

The invention relates to processing an image in a mobile communication device having a camera. An area on the user interface of the mobile communication device is selected. The selected area is shown together with an image to be captured by the camera and the captured image is stored as a part of the user interface on said selected area.

### FIELD OF THE INVENTION

The invention generally relates a mobile communication device having a camera for capturing images.

### BACKGROUND OF THE INVENTION

Mobile phones having integrated cameras have offered for their users many new possibilities to use. However, some possibilities have not yet been implemented or even invented.

In conventional camera phones the display of the phone is used as a viewfinder for the camera in order to assist in capturing an image. FIG. 1 shows a prior-art mobile phone 100. The mobile phone comprises a display 103, a keyboard 105, function keys 110, touch screen buttons 115, 125 and speaker holes 106. The image to be captured shows on the display of the phone in a camera application window 113. When the phone (or camera) is moved, the image moves in the window 113. When a suitable position has been found, the user captures the image by pressing a suitable key. The captured image is stored in the memory of the phone. After the image has been captured, the user can process or modify it, for example, in a drawing program. It is also possible to send the captured image as a multimedia (MMS) message to an email recipient.

It is also possible to set the captured image as a background image (wallpaper) on the phone. FIG. 2 shows the result of a prior-art method for setting a background. Often the captured image is of different size than intended thereby causing a problem. When setting the image as the background image, a part of the image might slip in the outside of the display, or the image in any other way might not fit into the display. For example, the main parts of the image might end up in the shadow of various user interface elements, such as icons 121, touch screen buttons 115, 125 or scroll bars 123. This is also the case with the display 103 shown in FIG. 2, wherein the downhill skier has remained behind the touch screen button 115 and part of the rightmost tree behind the vertical scroll bar 123.

In these cases, the problem can more broadly be formulated to be that the user does not know, at the moment when capturing the image, how the image fits for its intended use.

The U.S. Pat. No. 5,477,264 presents how a captured image can, at the moment when taking the image, be associated with a certain overlay or template so as to combine the captured image and the overlay or template into a single image. However, this solution only partially solves the whole problem. For example, it does not solve the part relating to setting the background image.

### SUMMARY OF THE INVENTION

It is an object of the invention to provide easier use of captured camera images as a part of other functions of the phone.

According to a first aspect of the invention, there is provided a method for processing an image in a mobile communication device having a camera, the method comprising:

selecting an area on the user interface of the mobile communication device;

showing the selected area together with an image to be captured by the camera,

wherein the method further comprises:

storing the captured image as a part of the user interface on said selected area.

Embodiments of the invention present a new way of modifying the appearance of the user interface (for example, display, touch screen button or a defined special area). In embodiments of the invention, the user can use a desired user interface element as a frame or delimiter of a camera image/photo to be captured. With the aid of an embodiment, the user can position a background image at its place already at the time when capturing the image. Alternatively or in addition to setting a background image for the whole area of the device display, the user can fill in or set a background image for individual/separate elements or areas of the user interface.

It is now easier to modify the user interface in accordance with embodiments of the invention. Basically, the user does not have to know anything of the structures of the background images or icons. It is enough just to select the right element and to capture the image directly to that element. This is in contrast to prior-art methods in which the user has to take a “normal” image and only after that the captured image can be set as a background image or wallpaper, or can be handled in a drawing program of the communication device.

In an embodiment of the invention, an existing user interface element is used to delimit the image to be captured (or taken) in that element, and the captured image is attached as an additional part to that element.

According to a second aspect of the invention, there is provided a mobile communication device having a camera, the mobile communication device further comprising:

a processing element for enabling selection of an area on a user interface of the mobile communication device;

the user interface for showing the selected area together with an image to be captured by the camera, wherein the mobile communications device is configured to store the captured image as a part of the user interface on said selected area.

According to a third aspect of the invention, there is provided a software product executable in a communication device having a camera, the software product comprising:

program code for enabling selection of an area on a user interface of the mobile communication device;

program code for causing the selected area to be shown together with an image to be captured by the camera, wherein the software product comprises:

program code for storing the captured image as a part of the user interface on said selected area.

The software product may comprise one or more computer program applications, comprising program code, stored on a medium, such as a memory.

It is another object of the invention to assist in taking images of certain shape.

Accordingly, in accordance with a fourth aspect of the invention there is provided a method for processing an image in a mobile communications device having a camera, the method comprising:

limiting an image to be captured by the camera into a beforehand-selected frame on a user interface, wherein the method further comprises:

storing the captured image without said frame.

In an embodiment, said frame is a frame other than the normal camera application window. It may be of an irregular shape, such as a heart.

In an embodiment, the beforehand-selected frame is formed by a user interface element, such as a touch screen key or button.

In an embodiment, any closed shape can be selected in a drawing program and the image can be captured into this shape. In an embodiment, the shape is not a frame in that sense that is not stored, but only the image of the selected shape is stored.

According to a fifth aspect of the invention, there is provided a mobile communications device having a camera, having a camera, the mobile communication device further comprising:

a processing element for limiting an image to be captured by the camera into a beforehand-selected frame on a user interface, wherein the mobile communications device is configured to store the captured image without said frame.

Dependent claims relate to embodiments of the invention. The subject matter contained in dependent claims relating to a particular aspect of the invention is also applicable to other aspects of the invention.

### BRIEF DESCRIPTION OF THE DRAWINGS

Embodiments of the invention will now be described by way of example with reference to the accompanying drawings in which:

FIG. 1 shows a prior-art camera phone display;

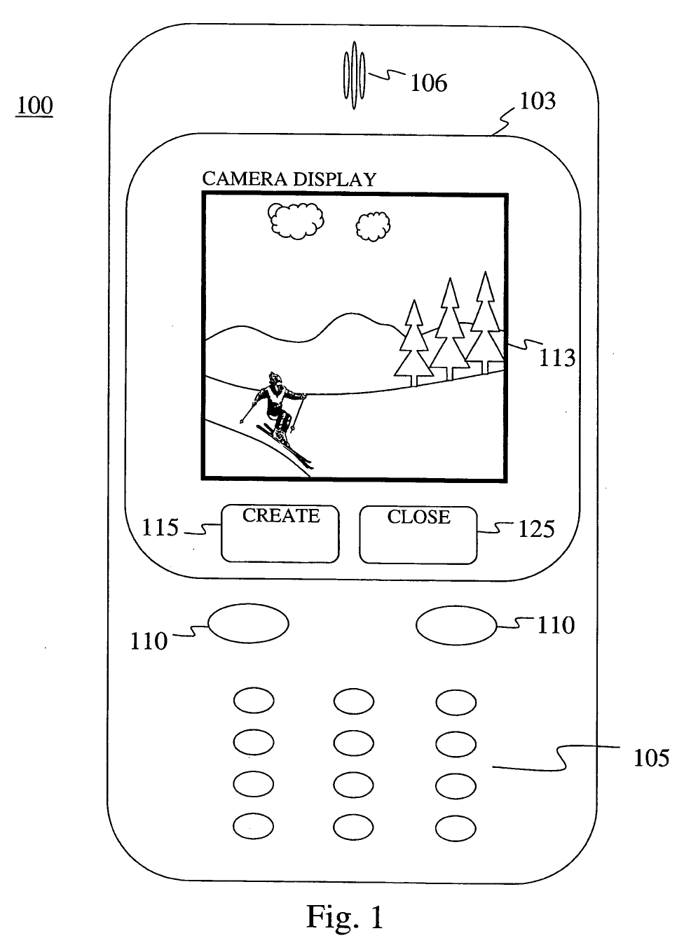

FIG. 2 shows a background image on the display of the prior-art phone of FIG. 1;

FIG. 3 shows an embodiment of the invention;

FIG. 4 shows another embodiment of the invention;

FIG. 5 shows yet another embodiment of the invention;

FIG. 6 shows yet another embodiment of the invention; and

FIG. 7 presents a block diagram showing details of a communication device in accordance with an embodiment of the invention.

### DETAILED DESCRIPTION

The subject matter contained in the introductory portion of this patent application can be used to support the detailed description.

In camera phones (or mobile communication devices having a camera) the user interface goes all the time with the camera, that is, the display of the phone is used as the viewfinder of (or viewscreen for) the camera. In other words, a display of the camera phone operates as a viewfinder of the camera when the camera phone is in camera mode.

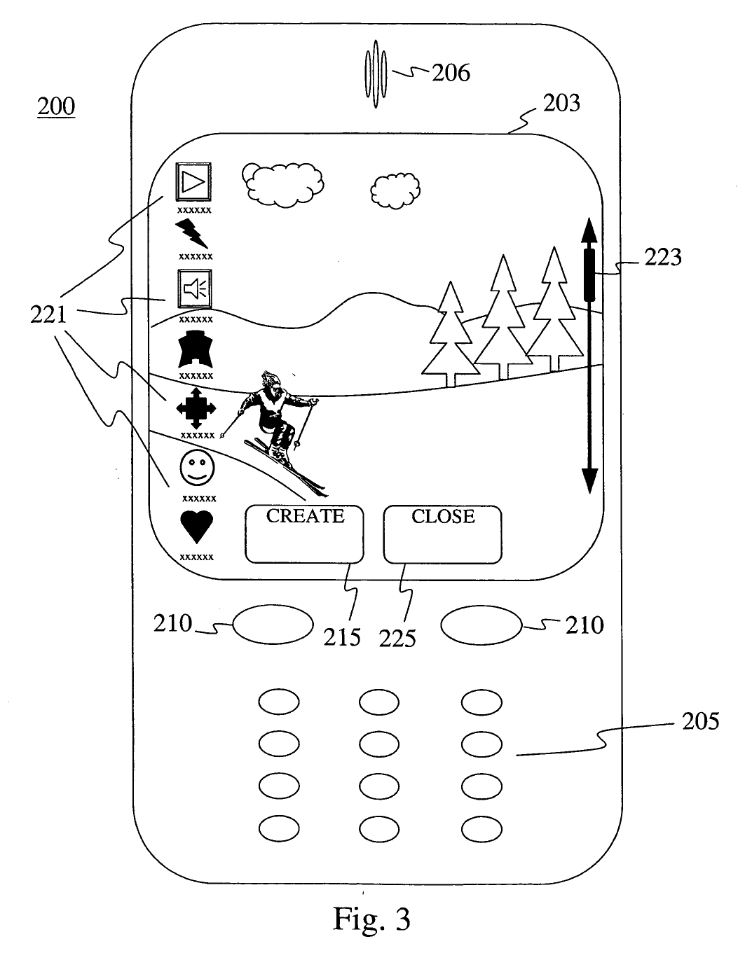

FIG. 3 shows an embodiment of the invention. The mobile phone 200 shown in FIG. 3 comprises a display 203, a keyboard 205, function keys 210, touch screen buttons 215, 225 and speaker holes 206. The mobile phone 200 has an integrated camera (not shown in FIG. 3; the camera may reside on the other side of the phone) and further comprises a camera application for operating the integrated camera. It further comprises a user interface customization application (hereinafter: the customization application) capable of modifying the appearance of the user interface of the phone. The two software applications co-operate so as to enable the user to customize the user interface of the phone (for example, the phone display 203) with image(s) captured by the camera.

Depending on the implementation, the camera application and/or the customization application is provided with a selection with the aid of which the user can take customized images for different purposes. If the user wants to take a background image on the phone display 203, the user first makes the appropriate selection by pressing a suitable key or choosing the selection from a menu.

Which of the applications has the overall control of the actions depends on the implementation. In one implementation, information on the user-made selection is passed from the customization application to the camera application which, in turn, passes image data (representing a camera image) to the customization application. The customization application performs appropriate processing on the image data to show the camera image on the whole area of the phone display.

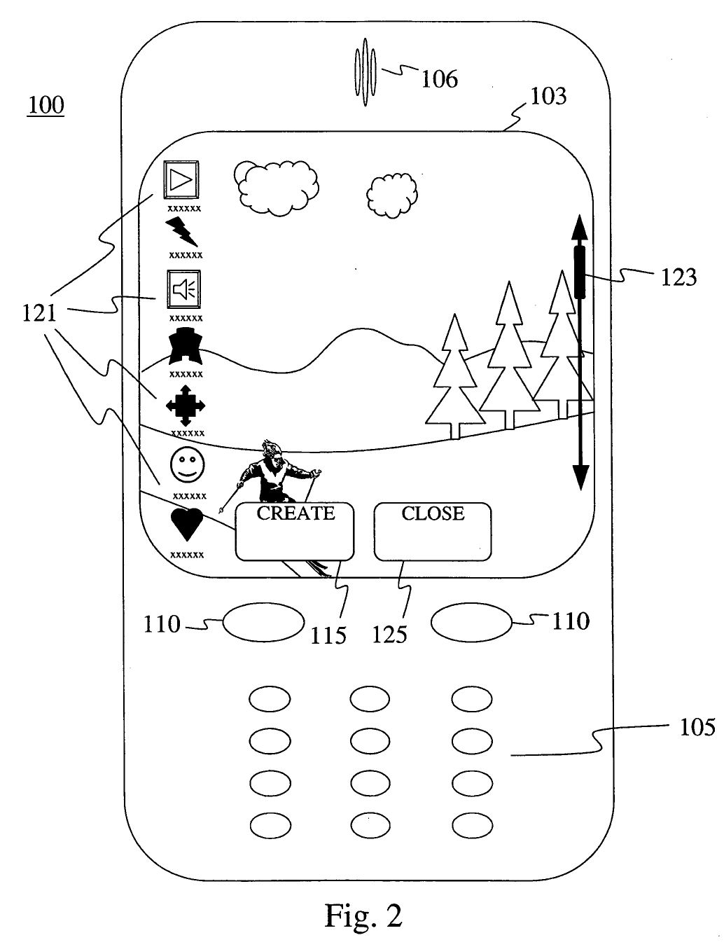

Now the user can see how the image to be captured will be positioned on the display 203 with respect to icons 221, touch screen buttons 215, 225 and other possible objects, such a the vertical scroll bar 223. When the phone (or camera) is moved, the image moves in the display 203 with respect to said objects. The icons 221, touch screen buttons 215, 225 and other objects may beforehand have been defined as unmovable objects so that they do not move together with the image to be captured. When an optimal position is found, the user can capture the image by pressing a suitable key. For example, one could imagine to use the “CREATE” touch screen button 215 for capturing the image. In the embodiment of FIG. 3 the user all the time sees the position of the camera image with respect to the outer borders of the display and other user interface objects. This makes it possible for the user to capture the image in a position in which the main parts of the image remain unshadowed. For example, in comparison to what is presented in FIG. 2, the downhill skier and the rightmost tree now remain in the clear area of the display 103.

The captured image is stored as the background image and it remains in the position and appearance seen by the user at the time when capturing the image.

Accordingly, in this embodiment, the user can see the ultimate appearance of the captured image already when shooting the image. This is in contrast to known prior art solutions in which the position of the background image with respect to other user interface objects can not be seen at the moment when capturing the image, therefore ending up to the problem of FIG. 2 explained in the foregoing.

The embodiment just described presented a customization application driven method. In an alternative embodiment, the camera application is in control of the actions. In this embodiment, the user makes, directly in the camera application, the selection to take the background image. The camera application either already knows or, if needed, is provided by the customization application with the size of the device display as well as the appearance and position of user interface objects which are to remain still on the display, such the icons 221, touch screen buttons 215, 225 and scroll bars 223.

Just as described in the foregoing, the user also in this embodiment can see how the camera image to be captured will be positioned on the display 203 with respect to icons, touch screen buttons and other objects. When the phone (or camera) is moved, the image moves in the display with respect to said objects. When the optimal position is found, the user captures the image by pressing a suitable key. The captured image is stored as the background image and it remains in the position and appearance seen by the user at the time when capturing the image.

Different layers can be used when setting the image as the background image. It is usually appropriate that the background image is put on the lowermost layer. The icons and scroll bars can be put on the uppermost layer so that they remain visible. The touch screen buttons can also be put on the uppermost layer so that the borders and/or the text remain visible. Whether the background image shows through in the inner area of the buttons depends on the properties of the button. If the button has “no fill”, the background image will show through.

While in the foregoing embodiments the captured image results in covering the whole area of the phone display, in other embodiments it is possible to select a smaller area. To generalize, the capturing of a background image on the phone display can be understood to comprise a selection of an area on the user interface and the placement of the captured image on said selected area knowing at the time the image is captured what the resulting appearance of the image on the display is going to be. The selected area can be the whole area of the phone display or an arbitrarily selected smaller area.

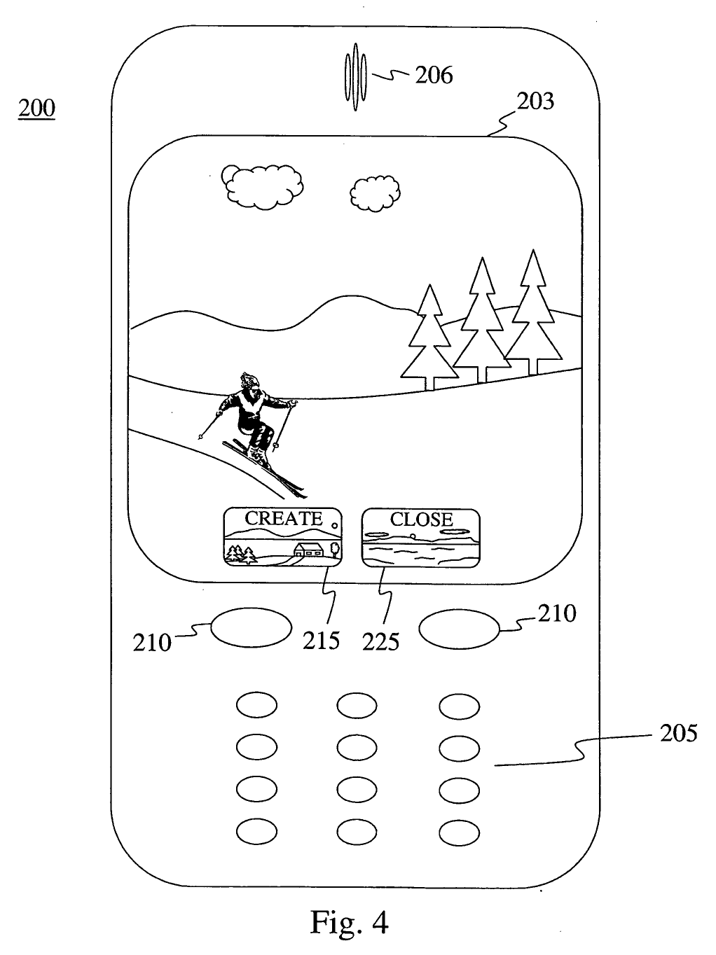

In another embodiments, the user can take images separately for different user interface objects/elements. In an embodiment, a user interface object/element is placed as a frame or overlay onto the image to be captured. The user interface objects/elements can be, for example, different sorts of touch screen keys and/or buttons. Just like in the embodiments presented in the foregoing, in a way, a context into which the image is to be captured is shown already when taking the image. In the embodiment shown in FIG. 4, the context is the touch screen button(s) 215, 225.

The present embodiment deviates from the background image embodiment in that now, instead of making the selection of taking a background image, the user now selects the touch screen button 215, 225 (or the area of the touch screen button).

Depending on the implementation, the customization application or the camera application shows the image to be captured in the button area. Now the user can see how the image to be captured will be positioned in the button area, for example, with respect to button text. In other words, the “viewfinder” of the camera shows how the image will place oneself as the background or fill of the button 215, 225. When the phone (or camera) is moved, the image moves in the viewfinder, that is, in the button area. The button text may beforehand have been defined as an unmovable object so that it does not move together with the image to be captured. When an optimal position is found, the user can capture the image by pressing a suitable key. The captured image is stored to the touch screen button 115, 125 as a fill or a background and it remains in the position and appearance seen by the user at the time when capturing the image. In a way, the captured image is stored as an additional part to the user interface element (here: the touch screen button).

In the embodiment of FIG. 4, it can be seen that a background image (presenting the downhill skier) has already been added on whole area of the display 203. In the area of touch screen buttons 215, 225 the newly captured images (a landscape image with a small house for the “CREATE” button 215 and a landscape image showing water, mountains and clouds for the “CLOSE” button 225) cover the background image which is on the bottom.

Different layers can be used also in this embodiment. It can be defined beforehand or afterwards that the button text will show on top of the captured image. This is an example of the “background case”. Alternatively, it can be defined that the image fills the button so that the text remains invisible. This is an example of the “fill case”. FIG. 4 illustrates the “background case”.

In a modification of the present embodiment, the area of the selected user interface element where the image is intended is of different size compared to the image provided by the camera. In that case, it may be appropriate for the customization or camera application to zoom or delimit the image so that it best fits into the selected area. However, also in this case, the user sees the appearance of the zoomed or delimited image before capture.

In another modification, the selected area/element is shown before and at the moment of the capture on the display in a size larger than in reality. This can help the user to better position the image to be captured, especially, if the selected area/element is small.

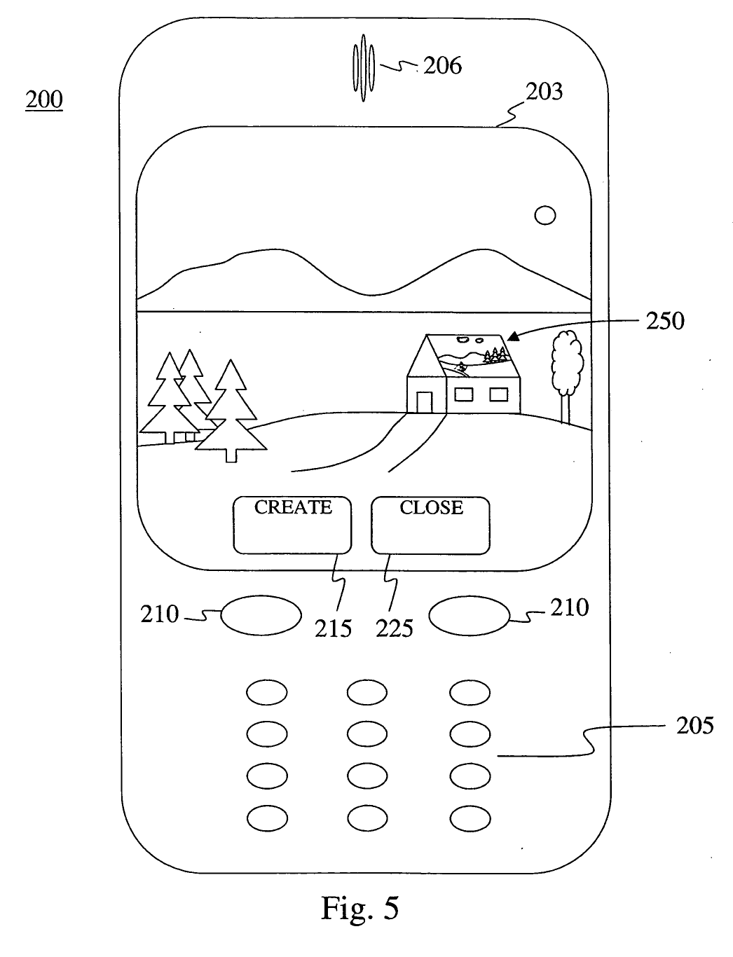

In another embodiment, the user can select or form in any suitable way any area of the display and take an image to there. FIG. 5 illustrates such an embodiment. The display 203 of the camera phone of FIG. 5 already has a background image. It may be a photo or another image. The user now selects any area he/she desires to place an image. In this case, the user activates the background image and selects the roof area 250 of the small house shown in the image.

Depending on the implementation, the customization application or the camera application shows the image to be captured in the selected area 250. Now the user can see how the image to be captured will place oneself in the selected area 250. When the phone (or camera) is moved, the image moves in the selected area 250. When an optimal position is found, the user can capture the image by pressing a suitable key. For example, one could imagine to use the “CREATE” touch screen button 215 for capturing the image. The captured image is stored to the selected area 250 and it remains in the position and appearance seen by the user at the time when capturing the image. In this way it is possible to capture images on top of one another.

The shape of the area selected for the image may be of irregular shape. In that case, it may be appropriate for the customization or camera application to zoom, delimit (e.g. leave a part of the image out), rotate or otherwise modify the image so that it best fits into the selected area. However, also in this case, the user sees the appearance of the zoomed, delimited, rotated or otherwise modified image before capture.

The selected area does not have to be a closed shape already appearing in the device display but in another embodiment, the user himself/herself can form an area whereto the image is put. In this embodiment, the user can select (or activate) with the aid of any suitable selection tool any area from the device display. For example, he/she can select an upper left quarter of the device display and shoot an image (e.g., a background image) there. Then he/she can select another quarter and shoot another image there, and so on, thereby creating kind-of a mosaic image.

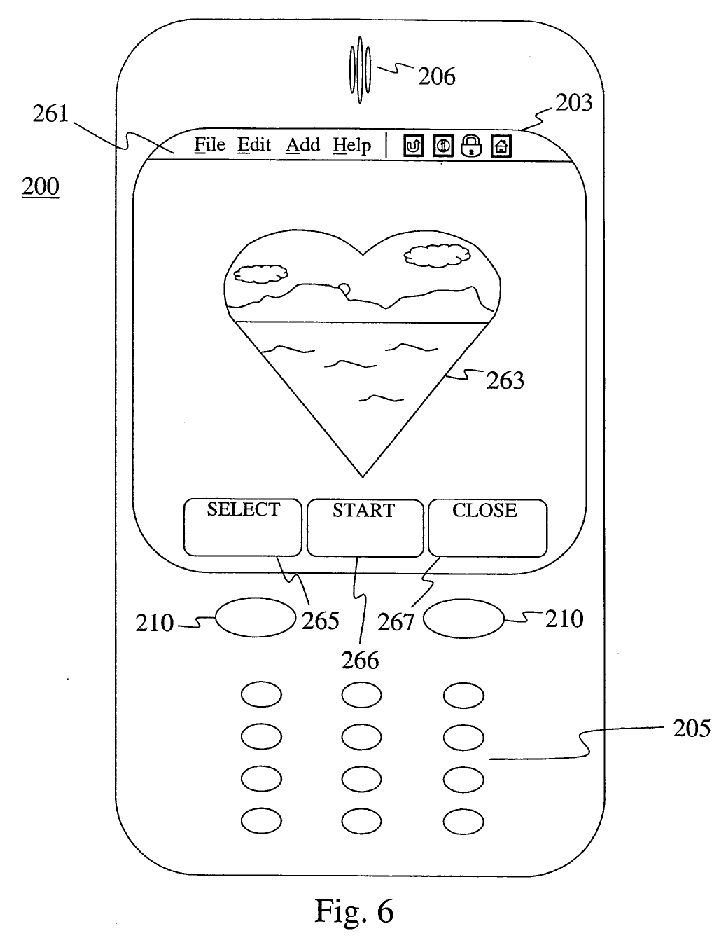

FIG. 6 illustrates yet another embodiment of the invention which relates to capturing images using beforehand-made frames. Such a frame the user can draw, for example, in a drawing program or he/she can select such a frame from any beforehand-made frame templates in the drawing program. For example, one could imagine to use the “SELECT” touch screen button 265 for selecting the frame.

After the user has selected a suitable frame (or shape) in the drawing program, he/she can capture an image having the shape of the selected frame. FIG. 6 shows a selected frame 263 having a shape of a heart in a drawing program window. The user can initiate the camera application by pressing a suitable key or by choosing from a drawing program menu 261 which has drop-down selections and icons. In practice, the camera application may be a separate application or it may be a separate or integral part of the drawing program.

The camera application and the drawing program co-operate in the same way as the camera application and the customization application in the previous embodiments in order to bring the camera image into the selected frame/shape 263. In this embodiment, the frame is only used as a delimiter tool in order to produce an image of the selected shape only. When the phone (or camera) is moved, the image moves in the frame area. When an optimal position is found, the user can capture the image by pressing a suitable key. For example, one could imagine to use the “START” touch screen button 266 for capturing the image. The captured image is stored in the memory of the phone without the frames which were intended for a delimiter tool only. It can be further processed in the drawing program or in another application. Since the frame is not stored with the picture, the size of the picture can be kept smaller thereby saving memory space in the mobile communication device 200.

The “CLOSE” touch screen button 267 does not directly relate to the present embodiment, but rather to other (closing) functions of the drawing program.

In the present embodiment, the shape of the selected frame may be of irregular shape. Therefore, it may be appropriate for the drawing program or the camera application to zoom, delimit (e.g. leave a part of the image out), rotate or otherwise modify the image so that it best fits into the selected area. The user sees the appearance of the zoomed, delimited, rotated or otherwise modified image before capture.

With this embodiment it is possible to rapidly capture images of irregular shape, such as a heart or another non-regular shape, however, so that the main parts of the captured image are well visible in the image. The present embodiment deviates from the solution presented in U.S. Pat. No. 5,477,264 in the way that in the present embodiment the captured image is stored without the frame. Also, in U.S. Pat. No. 5,477,264 only a regular rectangular shape is presented. In U.S. Pat. No. 5,477,264 a template is selected, the image is captured into the template and a combined image is formed, whereas in the present embodiment it is only an area which is selected and the image is put in there. No specific area nor the shape of the area is selectable in U.S. Pat. No. 5,477,264, only a suitable template is selected, whereas in the present embodiment the shape of the captured figure is selectable.

In a further embodiment, a user interface element is used as a beforehand-selected frame. This frame is used to limit an image to be captured by the camera. An image is stored without the frame for future use. It can be stored, for example, into a folder (i.e., a specified place in a memory) which can also contain other images to be used as background images or fill in different user interface elements, such as touch screen buttons. The user can then later select a background or fill into any user interface element for which an image has been taken and stored into the folder. Alternatively or in addition to storing the image into the folder, if an image to be captured is desired to be taken directly into use, just as described in the preceding embodiments, the captured image can be directly stored as a background or fill into the user interface element which is used as the frame or delimiter at the moment the image is captured. That image can then afterwards be replaced by another image stored earlier into the folder or to be captured later, if desired.

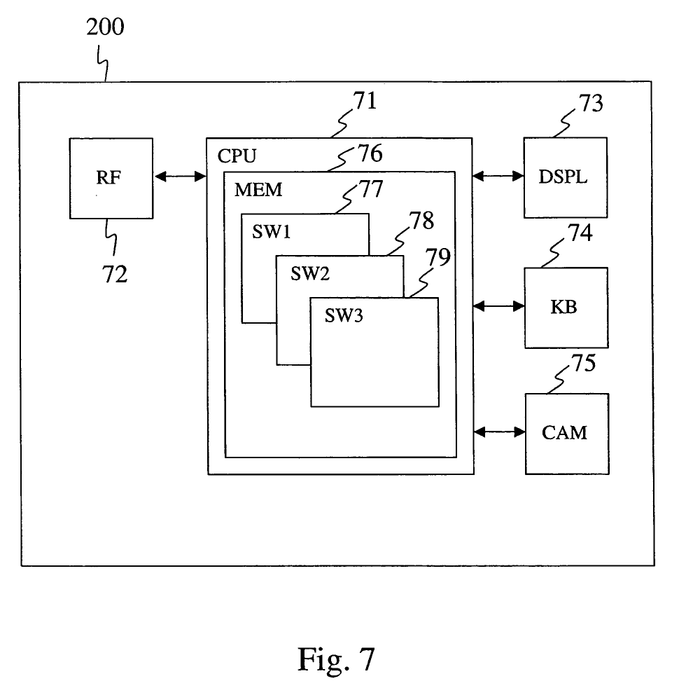

FIG. 7 presents a block diagram showing details of a mobile communication device 200 in accordance with an embodiment of the invention. The device may be, for example, a mobile communications device of a cellular network.

The device 200 comprises a processing unit 71, a radio frequency part 72 for cellular network operations, a display 73, a keyboard 74 and a camera 75, wherein the display 73 and the keyboard 74 form part of the user interface. The keyboard 74 may comprise both regular keys and/or buttons as well as touch screen keys and/or buttons on the display 73. The radio frequency part 72, the display 73, the keyboard 74 and the camera 75 are coupled to the processing unit 71.

The processing unit 71 comprises a processor (not shown) and a memory 76. Computer software is stored in the memory 76. It comprises program code for implementing the camera application 77, customization application 78 and the drawing program 79 mentioned in the foregoing.

The processor controls, in accordance with the software, the operation of the device, such as the operation of the radio frequency part 72 and the operation of the camera 75. It controls the co-operation between the software applications/programs in accordance with the presented embodiments of the invention in order to customize the user interface with images captured by the camera 75 and in order to produce images of the selected shape.

Embodiments of the invention provide the following advantages. It is easier to customize the user interface of the device when the user sees the actual resulting appearance of the image already when taking the image. Also, embodiments of the invention reduce the need for editing the images, which is considered difficult in a mobile device. Embodiments of the invention also allow the functions of the camera and the drawing application to co-operate.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. A method for processing an image in a mobile communication device having a camera, the method comprising:
selecting an area on the a user interface of the mobile communication device,
showing the selected area together with an image to be captured by the camera, and
storing the a captured image as a part of the user interface on said selected area.

2. The method of claim 1, wherein said selected area is an area on a display of the communication device.

3. The method of claim 1, wherein the method comprises using said selected area as a viewscreen for the image to be captured.

4. The method of claim 3, wherein the method comprises storing the image showing on the viewscreen in a position and appearance which shows at a moment of capture.

5. The method of claim 1, wherein the captured image is arranged to form a permanent part of the user interface until removed or replaced.

6. The method of claim 1, wherein the method comprises storing said captured image as a background image.

7. The method of claim 1, wherein a user interface element forms said selected area.

8. The method of claim 7, wherein the user interface element is placed as a frame or overlay onto the image to be captured.

9. The method of claim 7, wherein said user interface element is a touch screen key or button.

10. The method of claim 7, wherein the method comprises:
using said user interface element as a frame for the image, and
attaching said captured image as a part of said user interface element.

11. The method of claim 10, wherein the method comprises attaching said captured image directly to said user interface element as a fill or a background.

12. The method of claim 1, wherein the method comprises defining beforehand a set of fixed user interface objects.

13. The method of claim 12, wherein the method comprises showing said fixed objects on top of said captured image.

14. The method of claim 1, wherein the method comprises totally covering said selected area by said captured image.

15. The method of claim 1, wherein the method comprises modifying said image to be captured so that it better fits into the selected area.

16. A method for processing an image in a mobile communications device having a camera, the method comprising:
limiting an image to be captured by the camera into a beforehand-selected frame on a user interface, and
storing the captured image without said frame.

17. The method of claim 16, wherein said frame is a frame other than a normal camera application window.

18. The method of claim 17, wherein the frame has an irregular shape, such as a heart.

19. The method according to claim 16, wherein a user interface element is used as the beforehand-selected frame.

20. The method according to claim 19, wherein the captured image is configured to be taken directly into use in said user interface element.

21. A mobile communication device having comprising:
a camera and
a processing element for enabling selection of an area on a user interface of the mobile communication device, the user interface for showing the selected area together with an image to be captured by the camera, wherein the mobile communications device is configured to store the captured image as a part of the user interface on said selected area.

22. The mobile communication device of claim 21, wherein said selected area is an area on a display of the communication device.

23. The mobile communication device of claim 21, wherein said selected area is configured to be used as a viewscreen for the image to be captured.

24. The mobile communication device of claim 23, wherein the mobile communications device is configured to store the image showing on the viewscreen in the position and appearance which shows at the moment of capture.

25. The mobile communication device of claim 21, wherein the captured image is arranged to form a permanent part of the user interface until removed or replaced.

26. The mobile communication device of claim 21, wherein said captured image is configured to be stored as a background image.

27. The mobile communication device of claim 21, wherein said selected area is formed by a user interface element.

28. The mobile communication device of claim 27, wherein the user interface element is configured to be placed as a frame or overlay onto the image to be captured.

29. The mobile communication device of claim 27, wherein said user interface element is a touch screen key or button.

30. The mobile communication device of claim 27, wherein said user interface element is configured to be used as a frame for the image, and wherein said captured image is configured to be attached as a part of said user interface element.

31. The mobile communication device of claim 30, wherein said captured image is configured to be immediately attached to said user interface element as a fill or a background.

32. The mobile communication device of claim 21, wherein the mobile communication device comprises a set of beforehand-defined fixed user interface objects.

33. The mobile communication device of claim 32, wherein the mobile communication device is configured to show said fixed objects on top of said captured image.

34. The mobile communication device of claim 21, wherein said captured image is configured to totally cover said selected area.

35. The mobile communication device of claim 21, wherein said image to be captured is configured to be modified so that it better fits into the selected area.

36. A mobile communications device comprising:
a camera; and
a processing element for limiting an image to be captured by the camera into a beforehand-selected frame on a user interface, wherein the mobile communications device is configured to store the captured image without said frame.

37. A software product executable in a communication device having a camera, the software product comprising:
program code for enabling selection of an area on a user interface of the mobile communication device;
program code for causing the selected area to be shown together with an image to be captured by the camera; and
program code for storing the captured image as a part of the user interface on said selected area.
